(19) United States
(12) Patent Application Publication
(10) Pub. No.: US 2011/0110605 A1
(43) Pub. Date: May 12, 2011

(54) METHOD FOR GENERATING AND REFERENCING PANORAMIC IMAGE AND MOBILE TERMINAL USING THE SAME

(75) Inventor: Cheol Ho CHEONG, Seoul (KR)

(73) Assignee: SAMSUNG ELECTRONICS CO. LTD., Suwon-si (KR)

(21) Appl. No.: 12/943,496

(22) Filed: Nov. 10, 2010

(30) Foreign Application Priority Data
Nov. 12, 2009 (KR) 10-2009-0109045

(51) Int. Cl. G06K 9/36

(52) U.S. Cl. 382/284

(57) ABSTRACT

A method for generating a panoramic image is provided. The method includes photographing a plurality of images, obtaining contextual information with respect to each of the plurality of photographed images, and generating the plurality of photographed images as one panoramic image based on the obtained contextual information.

### PRIORITY

This application claims the benefit under 35 U.S.C. §119(a) of a Korean patent application filed on Nov. 12, 2009 in the Korean Intellectual Property Office and assigned Serial No. 10-2009-0109045, the entire disclosure of which is hereby incorporated by reference.

### BACKGROUND OF THE INVENTION

1. Field of the Invention

The present invention relates to a method for generating and inquiring a panoramic image in a mobile terminal. More particularly, the present invention relates to a method for generating and inquiring a panoramic image using a camera in a mobile terminal and a mobile terminal using the same.

2. Description of the Related Art

Recently, a camera function of a mobile terminal has been used to take a picture of an image. The mobile terminal includes a panoramic function among the camera function to take a picture of a scene having a wider range than a normal image range. However, in a conventional mobile terminal, as illustrated in FIG. 1, after taking a picture of a certain area, a picture of neighboring spaces of the certain area should also be taken to be partly overlapped and connect in a specific direction to the picture of the certain area to generate a panoramic image. Hence, the connecting and overlapping of the picture of the certain area and the pictures of the neighboring spaces is disadvantageous because a user has to move in specific directions from a spot where the user's picture of the certain area was photographed for the first time. More particularly, a distorted photograph can be generated as direction information is not provided when taking a picture of the certain area and the neighboring spaces.

Therefore, a need exists for a method and mobile terminal for easily generating a panoramic image in the mobile terminal.

### SUMMARY OF THE INVENTION

An aspect of the present invention is to address at least the above mentioned problems and or disadvantages and to provide at least the advantages described below. Accordingly, an aspect of the present invention is to provide a method for generating a panoramic image by adding contextual information to a photographed image to facilitate the matching of images.

Another aspect of the present invention is to provide a method for inquiring a panoramic image capable of providing information according to a context of user by using contextual information added for respective images.

Yet another aspect of the present invention is to provide a mobile terminal using a method for inquiring a panoramic image capable of providing information according to a context of user by using contextual information added for respective images.

In accordance with an aspect of the present invention, a method for generating a panoramic image is provided. The method includes photographing a plurality of images, obtaining contextual information with respect to each of the plurality of photographed images, and generating the plurality of photographed images as one panoramic image based on the obtained contextual information.

In accordance with another aspect of the present invention, a method for inputting panoramic image is provided. The method includes inquiring a previously generated panoramic image and contextual information, manipulating the inquired panoramic image according to an input of user, inputting additional information to the panoramic image according to an input of user, and storing the inputted additional information.

In accordance with still another aspect of the present invention, a method for inquiring a panoramic image includes searching the panoramic image by using at least one among a panoramic image list, contextual information, and additional information, recognizing the current contextual information of a mobile terminal, displaying the searched panoramic image, the contextual information, or the additional information, recognizing an operation command of the panoramic image and the additional information, and calculating the recognized contextual information of the mobile terminal and the contextual information of the panoramic image and displaying the panoramic image of the operation result.

In accordance with yet another aspect of the present invention, a portable terminal includes a photography unit photographing a plurality of images, a recognition unit sensing contextual information with respect to each of the plurality of photographed images, a controller generating the plurality of photographed images as one panoramic image based on the sensed contextual information, and a storage storing the sensed contextual information and the generated panoramic image.

According to exemplary embodiments of the present invention, the mobile terminal can more easily generate the panoramic image by using the contextual information which was generated in every image photographed. Moreover, the mobile terminal can provide information and service for a current context of a user by using generated contextual information. The user can search the panoramic image through the generated contextual information and additional information input to the panoramic image the information, and maybe provided with information or service which is suitable for a current context of the user.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 illustrates a picture of a certain area along with neighboring spaces taken by a mobile terminal of the related art;

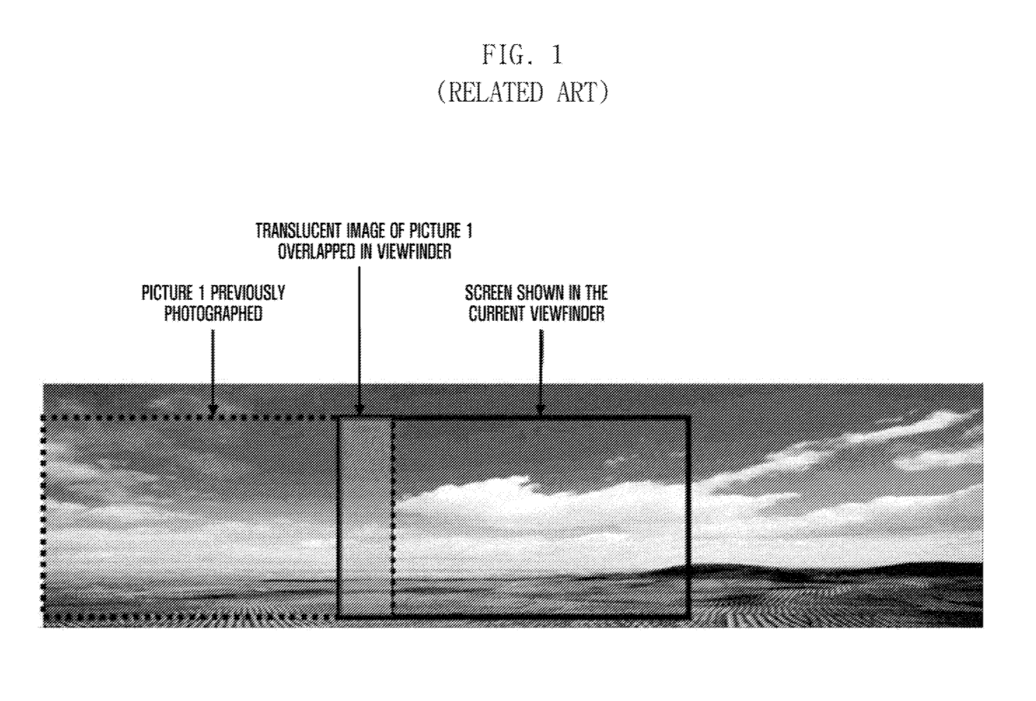

FIG. 2 is a block diagram illustrating a configuration of a mobile terminal for generating and inquiring a panoramic image according to an exemplary embodiment of the present invention;

FIG. 3 is a flowchart illustrating an operation for generating a panoramic image according to an exemplary embodiment of the present invention;

FIG. 4 illustrates a panoramic image configuration of a cylinder interior-exterior wall type virtual image space according to an exemplary embodiment of the present invention;

FIG. 5 illustrates an image space configuration according to an exemplary embodiment of the present invention;

FIG. 6 illustrates a panoramic image to which contextual information is added according to an exemplary embodiment of the present invention;

FIG. 7 is a flowchart illustrating an operation for inputting additional information of a panoramic image according to an exemplary embodiment of the present invention;

FIG. 8 is a flowchart illustrating an inquiry operation of a panoramic image according to an exemplary embodiment of the present invention; and

FIG. 9 illustrates a panoramic image inquiring method including additional information according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

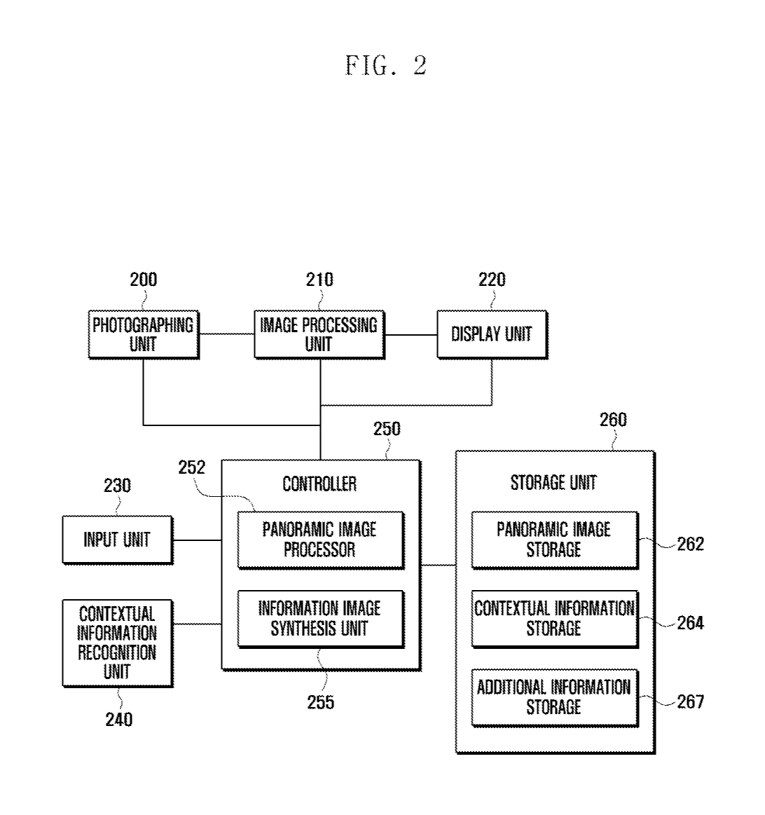

FIG. 2 is a block diagram illustrating a configuration of a mobile terminal for generating and inquiring a panoramic image according to an exemplary embodiment of the present invention.

Referring to FIG. 2, the mobile terminal for generating and inquiring the panoramic image includes a photographing unit 200, an image processing unit 210, a display unit 220, an input unit 230, a contextual information recognition unit 240, a controller 250, and a storage unit 260.

The photographing unit 200 performs a function of taking a picture of image data. Here, the photographing unit 200 includes a camera module, and may take a picture of a plurality of images for forming a panoramic image. The image processing unit 210 processes an image signal output from the photographing unit 200 with a frame unit and outputs frame image data according to a characteristic and size of the display unit 220. The image processing unit 210 includes an image codec which compresses the frame image data displayed on the display unit 220 with a set method or restores the compressed frame image data to original image data.

The image codec may be a Joint Photographic Experts Group (JPEG) codec, a Moving Picture Experts Group 4 (MPEG4) codec, and the like. Moreover, the image processing unit 210 may include an On-Screen Display (OSD) function, and may output on-screen display data according to the size of a displayed screen under the control of the controller 250. The display unit 220 displays an image signal output from the image processing unit 210 by screen and user data output from the controller 250. Here, the display unit 220 may be configured as a Liquid Crystal Display (LCD) and operate as the input unit 230, based on a touch pad or touch screen type display of the mobile terminal. The input unit 230 may include a plurality of numeric keys, a function key, a navigation key, and a touch screen or a touch pad, and transmits an input signal for the keys, the touch screen or the touch pad to the controller 250.

The contextual information recognition unit 240 recognizes contextual information photographed through the photographing unit 200. The contextual information recognition unit 240 may be configured as an apparatus, such as a Global Positioning System (GPS) module, a gyro sensor, an acceleration sensor, an ultrasonic sensor, a compass sensor, a light sensor, and the like, which may recognize the contextual information of the mobile terminal. Here, the contextual information includes at least one of azimuth angle information, horizontal angle information, location information, height information, rotation angle information, light information of a photographed image, and distance information to an object. The contextual information may be obtained by using a plurality of sensors when contextual information is provided on a three-dimensional space. The controller 250 controls overall operations of the mobile terminal for generating and inquiring a panoramic image. Hereinafter, a description of general processing and control of the controller 250 is omitted.

In an exemplary implementation, the controller 250 may include a panoramic image processor 252 and an information image synthesis unit 255. Here, the panoramic image processor 252 converts a plurality of images photographed based on the contextual information into one panoramic image. The information image synthesis unit 255 may record additional information input through the contextual information or the input unit 230 into the panoramic image or synthesize the additional information with the panoramic image to generate a new panoramic image including at least one of the contextual information or the additional information. Here, the additional information may include text, an image, a figure, an icon, a thumbnail, multimedia information, and the like.

The storage unit 260 stores the contextual information detected through the contextual information recognition unit 240 and the panoramic image generated through the controller 250. At this time, the storage unit 260 may store the additional information input through the input unit 230 by a user. In an exemplary implementation, the storage unit 260 includes a panoramic image storage 262, and a contextual information storage 264, and may further include an additional information storage 267. The panoramic image storage 262 stores the panoramic image generated in the controller 250. Here, the stored panoramic image may correspond to an image generated through the panoramic image processor 252 and an image generated through the panoramic image processor 252 and the information image synthesis unit 255.

In a case where the contextual information is included in or the additional information is input to the panoramic image generated through the panoramic image processor 252, the panoramic image is generated while including the additional information by the information image synthesis unit 255. When both the contextual information and the additional information exist, the information image synthesis unit 255 generates a panoramic image while including both of the contextual information and the additional information.

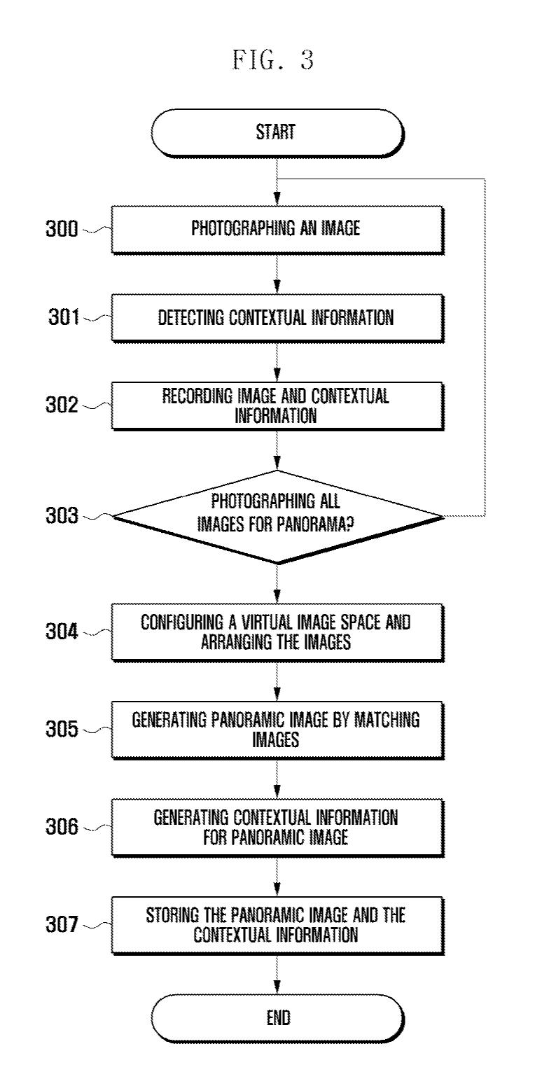

FIG. 3 is a flowchart illustrating an operation for generating a panoramic image according to an exemplary embodiment of the present invention.

Referring to FIG. 3, the controller 250 of the mobile terminal executes a camera photography mode and controls the photographing unit 200 to take a picture of an image in step 300. The controller 250 also controls the contextual information recognition unit 240 to detect contextual information in step 301. For example, when the contextual information is direction information, azimuth angle information, horizontal angle information or rotation angle information, the contextual information may be detected through a gyro sensor or a compass sensor. When the contextual information is distance information between a photographing device and a subject, the ultrasonic sensor may be utilized to detect the distance information. When the contextual information is light information such as brightness of the image and the change of color, the light sensor may be utilized to detect the light information. Also, when the contextual information is location information or height information, the contextual information may be detected through a GPS module.

Here, the controller 250 stores the detected contextual information in the contextual information storage 264 of the storage unit 260 in step 302. At this time, the controller 250 may store the photographed image in the storage unit 260. If the controller 250 did not take a picture of all images for panoramic in step 303, the operation returns to step 300 and controls the photographing unit 200 to continuously take a picture of the image. At this time, by using the contextual information of a previously photographed image whenever the mobile terminal moves, the controller 250 may provide correction information of a photographing area for the current preview image output to the display unit 220. For example, if the azimuth angle information is stored in the previously photographed image, a range photographed in the previous image is illustrated in a current preview image, and the user may take a picture of a new image by moving the photographing unit 200 to adjust to the range. The previously photographed range may be displayed by a line, a figure, and a sign, or may be semi-transparently illustrated in the preview image. Moreover, when the mobile terminal reaches a suitable location for a panoramic shot, if the mobile terminal automatically takes a picture or the photographing unit 200 is positioned at a suitable location for the photography, the controller 250 controls the display unit 220 to display by using at least one of a figure, text, a sign, sound, vibration, and flickering of light. In a case where the operation for forming a panoramic image from a plurality of photographed images is terminated, the controller 250 configures a virtual image space and arranges the plurality of photographed images in the virtual image space to be adjusted in step 304. Here, the virtual image space corresponds to a two dimensional or three dimensional imaginary space consisting of a plurality of images and corresponding respective contextual information.

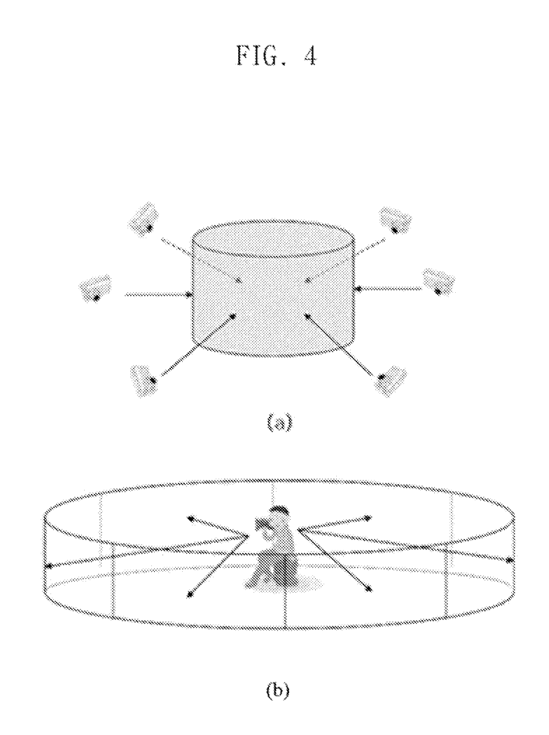

For example, the controller 250 may configure the virtual image space as a linear space. In this case, the plurality of photographed images are configured as a coplanar image. On the other hand, referring to FIG. 4, when the user rotates around one place or one subject while taking a picture of an image, the controller 250 may configure the virtual image space as a cylinder type.

FIG. 4 illustrates a panoramic image configuration of a cylinder interior-exterior wall type virtual image space according to an exemplary embodiment of the present invention.

Referring to diagram (a) of FIG. 4, a plurality of photographed images are arranged in an exterior wall portion of the cylinder type that is the virtual image space. Diagram (b) illustrates the user rotating the mobile terminal 360 degrees to make a circle while photographing the image. A plurality of photographed images are arranged in the interior wall portion of the cylinder type virtual image space. The controller 250 may arrange the photographed images in the inner wall or the exterior wall portion of the cylinder by using contextual information of respective images. At this time, the contextual information may be direction information, location information, and height information or azimuth angle information. On the other hand, when the virtual image space is configured as a 3D spherical shape, the controller 250 may arrange the plurality of photographed images in the inner wall or the exterior wall of the spherical shape by making use of the direction information, the horizontal angle information, the rotation angle information or the azimuth angle information.

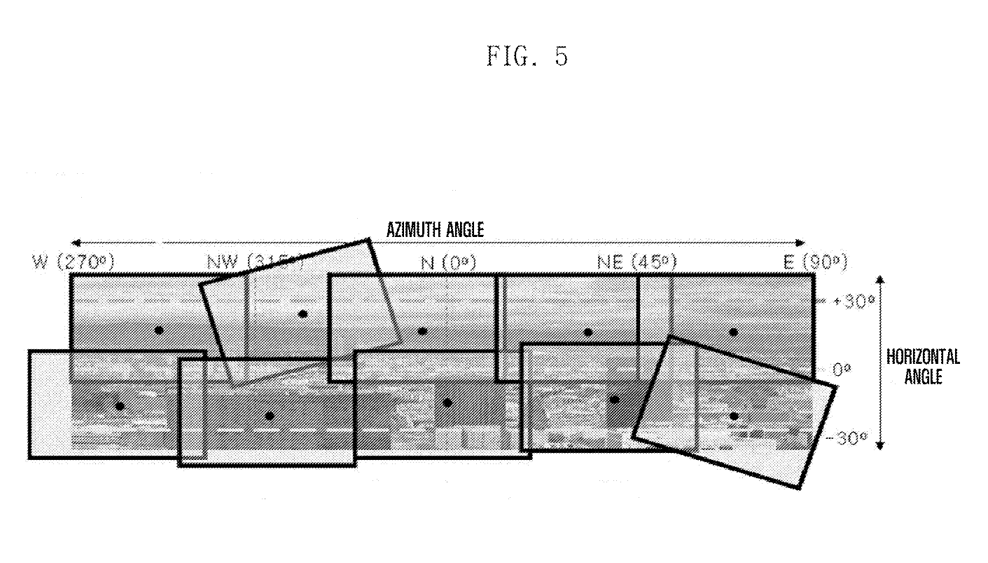

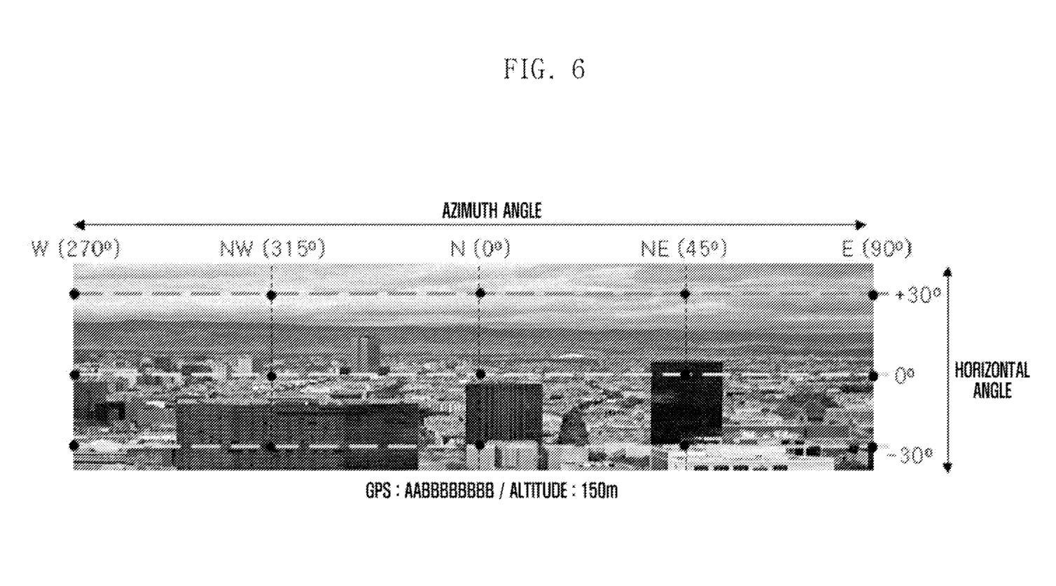

FIG. 5 illustrates an image space configuration according to an exemplary embodiment of the present invention. FIG. 6 illustrates a panoramic image to which contextual information is added according to an exemplary embodiment of the present invention.

Referring to FIG. 5, according to azimuth angle information, horizontal angle information, and rotation angle information, which are respective contextual information, respective images may be arranged in the virtual image space. Referring back to FIG. 3, the panoramic image processor 252 generates arranged images as one panoramic image in step 305. At this time, the panoramic image processor 252 enlarges, reduces, rotates or changes images which are overlapped or adjacent through image analysis, matching, and deformation. The panoramic image processor 252 may generate the arranged images as one panoramic image by using the contextual information. After generating the panoramic image, the controller 250 generates at least one contextual information for panoramic image by using the contextual information of respective images in step 306. For example, referring to FIG. 6, the contextual information may correspond to the azimuth angle information, the horizontal angle information, the location information through GPS, and the altitude information. In this case, the contextual information for panoramic image may be generated with respect to pixels of a given interval based on the respective corresponding contextual information. The controller 250 stores the panoramic image and the contextual information in the storage 260 in step 307. At this time, the controller 250 stores the panoramic image in the panoramic image storage 262, and may store the contextual information in the contextual information storage 264. Here, the panoramic image may be stored together with location information of the image, a keyword or thumbnail information to search or inquire images. After storing the panoramic image and the contextual information, the controller 250 terminates the generation of panoramic image. Moreover, the panoramic image generating method may further include a process for quality improvement of the panoramic image to improve a panoramic image quality.

For example, if the panoramic image is configured when brightness and color of the images are different although the photographed images are connected with each other, it is difficult to consider the images as one panoramic image since respective brightness and color are different. Accordingly, the brightness and the color of the images may be corrected through the panoramic image processor 252 of the controller 250. At this time, the controller 250 may take a picture of the images by previously changing the setting of the image input characteristic of the photographing unit 200, or the panoramic image processor 252 may correct the respective photographed images.

The image input characteristic may include at least one of illuminance, color correction, gamma correction, white balancing, and a setting of an illumination type. When the panoramic image processor 252 matches the images, respective images may be corrected and matched or may be corrected after matching. Moreover, the panoramic image processor 252 may correct the image quality against total pixels in the generated panoramic image. At this time, an image quality technique may include at least one of the white balancing, a gray world assumption technique, a white world assumption technique, a retinex algorithm, a Bayesian color correction technique, a correlation-based color correction technique, a gamut mapping technique, and a neural network-based color correction technique.

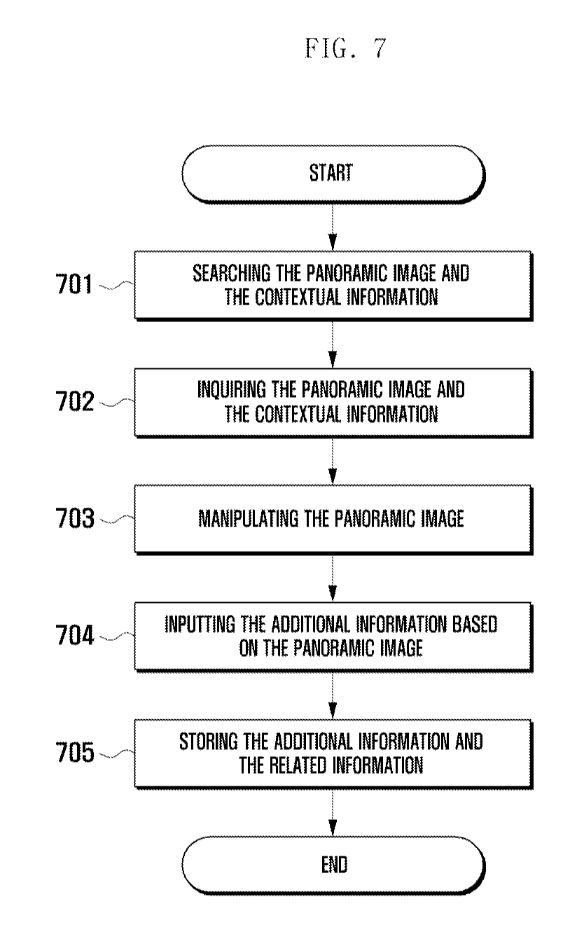

FIG. 7 is a flowchart illustrating an operation for inputting additional information of a panoramic image according to an exemplary embodiment of the present invention.

Referring to FIG. 7, the controller 250 receives a search command of the panoramic image and contextual information through the input unit 230 in step 701. The contextual information may be used to search the panoramic image and the contextual information. For example, the panoramic image of a specific location may be obtained by inputting a desired location using a geographical information system when searching the contextual information, or the panoramic image having location information within a certain distance may be searched by recognizing the location information of the mobile terminal using a GPS module mounted in the mobile terminal. In addition to the above described methods, a keyword search, and a file name search, which are normal user interfaces, may be used. The controller 250 inquires the panoramic image and the contextual information to which the search command is input in step 702, and may manipulate the panoramic image by the input of a user in step 703. At this time, the controller 250 may reduce, rotate, and move the panoramic image by the input of the user. Moreover, the controller 250 may measure the contextual information such as movement or tilting of the terminal by using a gyro sensor, and accordingly, may rotate or move the panoramic image. Thereafter, according to the input of the user, the controller 250 controls the input unit 230 and recognizes the input of the additional information for the panoramic image in step 704. For example, the user may paint, indicate, or insert text in a specific portion of the panoramic image by a pen writing method. On the other hand, the user may add information such as multimedia, voice to the panoramic image, or may input a hyperlink to the panoramic image to connect online by using an icon, text, a thumbnail, and the like. The storage unit 260 stores the input additional information in the additional information storage 267 in step 705. The controller 250 controls the display unit 220 to always display the additional information on the panoramic image, or may display or remove the additional information on the panoramic image when a specific command (e.g., a pointing input such as a pen touch, a finger touch, a mouse input, and a button input) is input through the input unit 230. For example, when the user selects a specific building of the panoramic image, the controller 250 controls the display unit 220 to display the additional information for the selected building. In an exemplary implementation, the additional information may be displayed to overlay on an original copy of the panoramic image. When storing the additional information in the additional information storage 267, the controller 160 may store the location information on the panoramic image on which the additional information is to be displayed together with the additional information, and the display method information for displaying with an icon or text.

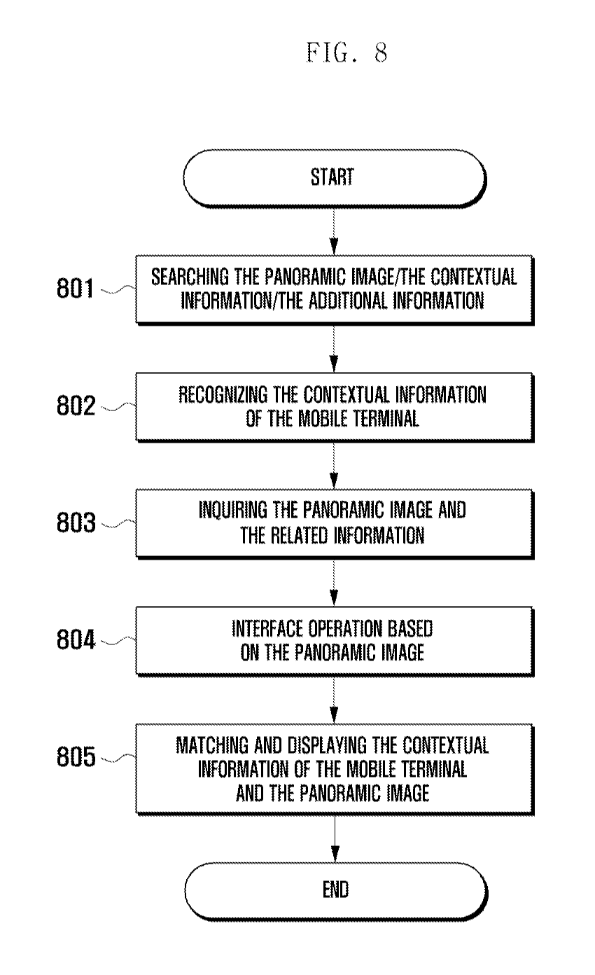

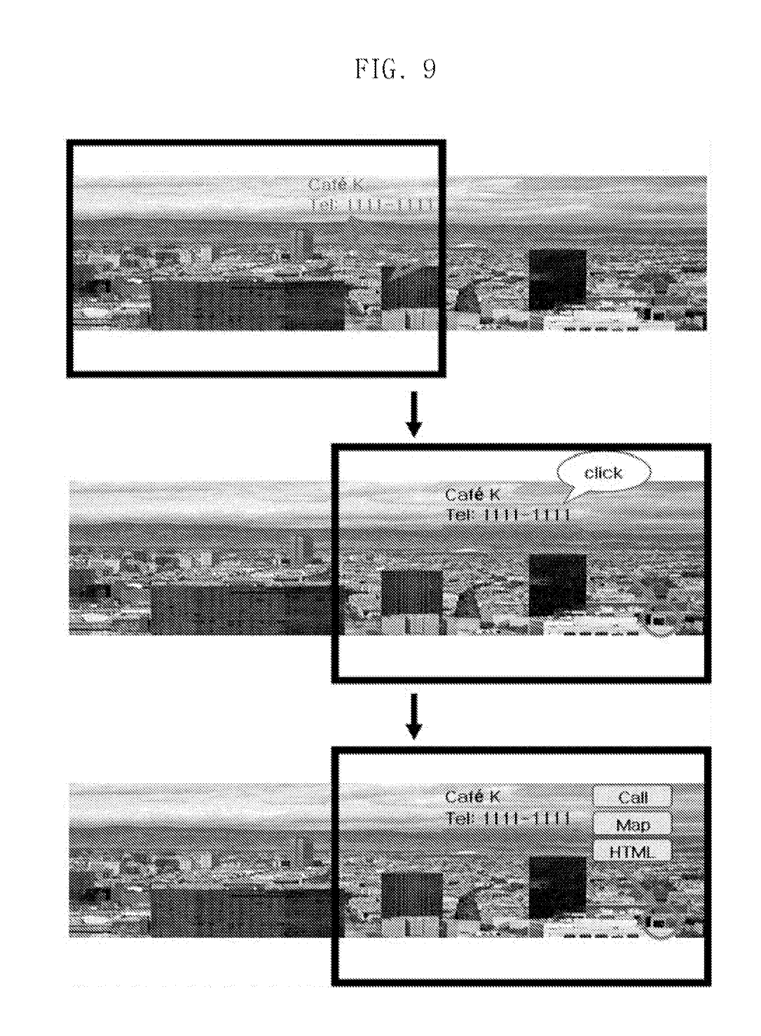

FIG. 8 is a flowchart illustrating an inquiry operation of a panoramic image according to an exemplary embodiment of the present invention. FIG. 9 illustrates a panoramic image inquiring method including additional information according to an exemplary embodiment of the present invention.

Referring to FIG. 8, the controller 250 recognizes a panoramic image search command through a selection of at least one of a panoramic image list, contextual information or additional information from the input unit 230 in step 801. If a user selects at least one of the panoramic images of the panoramic image list, the contextual information or the additional information through the input unit 230, the controller 250 receives a signal from the input unit 230 and recognizes that the panoramic image search command is input. When searching with the panoramic image list, the controller 250 controls the display unit 220 to display the stored panoramic images in a list of a preview format, or with a title of panoramic image, a key word, and a thumbnail. The user may select at least one panoramic image from among the list displayed on the display unit 220. In addition, when searching the panoramic image, the user may search the panoramic image classified by an additional information creator and an additional information creating time. For example, the user makes it possible to search only the additional information which was created by a specific user, device, or organization, or the additional information which was made in a specific time zone. Thereafter, the controller 250 controls the contextual information recognition unit 240 to recognize the current contextual information of the mobile terminal in step 802. Accordingly, the controller 250 inquires the panoramic image, the contextual information, and the additional information in step 803.

In step 803, the controller 250 controls the display unit 220 to display the searched panoramic image, the contextual information and the additional information relating to the searched panoramic image. The controller 250 controls the input unit 230 to recognize the input of the user, rotate, change, enlarge, reduce the panoramic image according to the input of the user, additionally inquire, search the panoramic image, or to add, delete, search, and modify the additional information in step 804. Thereafter, the controller 250 controls the display unit 220 to display the contextual information or the additional information in the panoramic image in step 805. More particularly, the controller 250 matches the contextual information of the mobile terminal recognized in step 802 and the contextual information of the panoramic image, controls the display unit 220 to display the panoramic image of the matching result. Moreover, the controller 250 controls the display unit 220 to selectively display the additional information to the panoramic image.

For example, referring to FIG. 9, when user A does not know an exact location to meet user B at cafe K near a subway station, user B searches the panoramic image around the subway station by user B's mobile terminal, displays a location or a telephone number of the cafe K with a sign, a letter, or a number through the input unit such as a touch screen or a key input, and transmits the location or the telephone number to user A. User A stores the panoramic image received from user B in the mobile terminal. When user A comes out of the subway station and executes the panoramic image inquiry, the mobile terminal determines the current position through the GPS module, searches the panoramic image for the current location surrounds and displays the surroundings. At this time, the mobile terminal of user A may overlay the additional information generated by the user B in the searched panoramic image to display. The mobile terminal of user A inquires the panoramic image received from user B, recognizes direction information and shows a corresponding panoramic image.

The mobile terminal of user A determines whether the direction information of the mobile terminal of the user A coincides with the direction of cafe K. If it is determined that the direction information does not coincide with the direction of the cafe K, the information regarding the cafe K is not displayed. If it is determined that the direction information of the cafe K coincides with the direction information of the mobile terminal of user A, the information regarding the location of the cafe K or the telephone number which user B input may be output on the panoramic image. As a result, it is possible to call the telephone number, display a map of the location of cafe, or access a web site home page of the cafe K when user A clicks or touches corresponding information.

According to an exemplary embodiment of the present invention, in a case where a mobile terminal of user A includes a gyro sensor or a compass sensor, the mobile terminal of user A reconciles a current azimuth angle of the mobile terminal with the azimuth angle of a panoramic image by using the azimuth angle information of the mobile terminal and the azimuth angle information of the current azimuth angle information of the mobile terminal, such that a corresponding panoramic image may be output. At this time, the mobile terminal may output the panoramic image corresponding to the current azimuth angle by detecting the movement of the mobile terminal. Therefore, if the user moves with the mobile terminal, the user may easily move to a desired destination based on the panoramic image corresponding to the azimuth. More particularly, if additional information regarding the destination exists, a service such as a telephone call, transmitting message, internet access may be utilized by using the additional information.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A method for generating a panoramic image, the method comprising:
photographing a plurality of images;
obtaining contextual information with respect to each of the plurality of photographed images; and
generating the plurality of photographed images as one panoramic image based on the obtained contextual information.

2. The method of claim 1, wherein the contextual information includes at least one of direction information, azimuth angle information, horizontal angle information, location information, height information, rotation angle information, light information of the photographed image, and distance information between a photographing device and a subject.

3. The method of claim 1, further comprising:
generating contextual information for the panoramic image by using the contextual information of the generated panoramic image.

4. The method of claim 1, wherein the obtaining of the contextual information comprises:
detecting the contextual information when photographing the image; and
storing the detected contextual information in response to the photographed image.

5. The method of claim 1, wherein the generating of the plurality of photographed images as one panoramic image comprises:
arranging the photographed images on at least one of a two dimensional space and a three dimensional space based on the contextual information; and
connecting and matching adjacent images among the images arranged on the space.

6. The method of claim 1, further comprising:
a photographing area correction process for correcting and displaying an area of image for photographing by using the contextual information corresponding to the previously photographed image.

7. The method of claim 6, wherein the photographing area correction process displays a location of the image for photographing by using at least one of an image, a figure, a sign, sound, vibration, and a flickering of light.

8. The method of claim 1, further comprising a panoramic image quality improvement process for improving a quality of the panoramic image.

9. The method of claim 8, wherein the panoramic image quality improvement process uses at least one of white balancing, a gray world assumption technique, a white world assumption technique, a retinex algorithm, a Bayesian color correction technique, a correlation-based color correction technique, a gamut mapping technique, and a neural network-based color correction technique.

10. A method for inputting panoramic image additional information, the method comprising:
inquiring a previously generated panoramic image and contextual information;
manipulating the inquired panoramic image according to an input;
inputting additional information to the panoramic image according to the input; and
storing the input additional information.

11. The method of claim 10, wherein the additional information includes at least one of text, voice, a photograph, multimedia, an icon, a figure, and a thumbnail.

12. A method for inquiring a panoramic image, the method comprising:
searching the panoramic image by using at least one of a panoramic image list, contextual information and additional information;
recognizing current contextual information of a mobile terminal;
displaying at least one of the searched panoramic image, the contextual information, and the additional information;
recognizing an operation command of the panoramic image and the additional information;
determining the recognized contextual information of the mobile terminal and the contextual information of the panoramic image; and
displaying the panoramic image of the operation result.

13. The method of claim 12, further comprising:
selectively displaying the additional information in the panoramic image.

14. A portable terminal comprising:
a photographing unit for photographing a plurality of images;
a recognition unit for detecting contextual information with respect to each of the plurality of photographed images;
a controller for generating the plurality of photographed images as one panoramic image based on the detected contextual information; and
a storage unit for storing the detected contextual information and the generated panoramic image.

15. The portable terminal of claim 14, wherein the storage unit comprises:
a panoramic image storage for storing a panoramic image; and
a contextual information storage for storing the detected contextual information.

16. The portable terminal of claim 15, wherein the contextual information includes at least one of direction information, azimuth angle information, horizontal angle information, location information, height information, rotation angle information, and light information of the photographed image, and distance information between a photographing device and a subject.

17. The portable terminal of claim 15, further comprising:
an input unit for inputting the additional information.

18. The portable terminal of claim 17, wherein the storage unit comprises an additional information storage unit for storing the additional information.

19. The portable terminal of claim 15, wherein the controller further comprises at least one of an information image synthesis unit for recording the additional information and the contextual information on the panoramic image.

20. The portable terminal of claim 14, wherein the contextual information recognition unit includes at least one of a Global Positioning System (GPS) module, a gyro sensor, an acceleration sensor, a compass sensor, an ultrasonic sensor, and a light sensor.
